(19) United States
(12) Patent Application Publication
(10) Pub. No.: US 2026/0243951 A1
(43) Pub. Date: Aug. 20, 2026

(54) POLARIZATION-DIVERSE INTEGRATED PHOTONIC SWITCH WITH MULTI-LAYER WAVEGUIDES

(71) Applicants: NEYE SYSTEMS, INC., Emeryville, CA (US); THE REGENTS OF THE UNIVERSITY OF CALIFORNIA, Oakland, CA (US)

(72) Inventors: Tae Joon SEOK, El Cerrito, CA (US); Johannes HENRIKSSON, Walnut Creek, CA (US); Kyungmok KWON, El Cerrito, CA (US); Jianheng LUO, Berkeley, CA (US); Ming Chiang A. WU, Piedmont, CA (US)

(21) Appl. No.: 19/162,608

(22) PCT Filed: Mar. 6, 2024
(86) PCT No.: PCT/US2024/018738

§ 371 Date: Sep. 5, 2025

Related U.S. Application Data
(60) Provisional application No. 63/488,741, filed on Mar. 6, 2023.

(51) Int. Cl. G02B 6/12; G02B 6/122; G02B 6/125

(52) U.S. Cl. CPC G02B 6/12002; G02B 6/1228; G02B 6/125; G02B 2006/12116; G02B 2006/12145; G02B 2006/12147; G02B 2006/1215

(57) ABSTRACT

Photonic integrated circuits (PICs) are provided and include polarization-diverse silicon photonic switches with multi-layer waveguides. The PICS of the present disclosure can be applied or used in a wide variety of fields including but not limited to fiber-optic communication, photonic computing, and light detection and ranging (LiDAR). The proposed PICs can include switches having two polarization-decomposed channels that propagate in closely spaced dual-channel waveguides, achieving polarization diverse operation without increasing the PIC area. By using two-layer waveguides and dual-channel micro-electro-mechanical-system (MEMS)-actuated switching elements to couple light from one layer to the other, the proposed scheme also eliminates waveguide crossings found in the prior arts.

### PRIORITY CLAIM

This patent application claims priority to U.S. provisional patent application no. 63/488,741, titled “POLARIZATION-DIVERSE INTEGRATED PHOTONIC SWITCH WITH MULTI-LAYER WAVEGUIDES,” and filed on Mar. 6, 2023, which is herein incorporated by reference in its entirety.

### STATEMENT AS TO FEDERALLY SPONSORED RESEARCH

This invention was made with Government support under contract/grant number HR0011-19-2-0015 awarded by the Defense Advanced Research Projects Agency (DARPA) and contract/grant number DE-AR0000849 awarded by the Advanced Research Projects Agency-Energy (ARPA-E). The Government has certain rights in the invention.

### FIELD

This disclosure relates to optical communication networks. More specifically, the present disclosure details novel polarization-diverse integrated photonic switches, with low polarization-dependent loss, low different group delays, and low on-chip loss.

### BACKGROUND

The emergence of data-intensive cloud computing, high performance computing (HPC), artificial intelligence (AI) and machine learning (ML) systems has led the explosive growth of data traffics in data center networks. Conventional electrical packet switches which support optical networks in present data centers are facing increasing challenges in energy consumption as the required data rate, which is the speed of data transmission, continues to increase. Optical circuit switches can solve these challenges by offering unlimited bandwidth thanks to their low power consumption, which is agnostic to the data rate.

Silicon photonics leveraging advanced CMOS foundry manufacturing is a viable technology platform to demonstrate large-scale optical switches. Silicon photonic devices typically employ waveguides formed in a thin silicon-on-insulator (SOI) layer, where a myriad of photonic components are routed by the waveguides to provide a complex functionality. Integrated optical switches implemented on silicon photonics platform, so-called silicon photonic switches, offer high-density integration and low-cost manufacturing. However, their operation is typically limited to a fixed light polarization (TE or TM) owing to the birefringent nature of their rectangular-shaped waveguides.

Polarization-diverse silicon photonic devices have been proposed to address this polarization issue, where propagating light of arbitrary polarization is decomposed to two channels of light with a same favored polarization by a polarization-handling photonic component such as polarization splitter rotator (PSR). Each split channel is sent to and passes through a duplicate photonic integrated circuit (PIC), and finally the two channels are combined again into one waveguide by another polarization component such as polarization-splitter-rotator (PSR). Therefore, polarization-diverse silicon photonic devices typically require twice the area for the duplicate PICs. Furthermore, a myriad of waveguide crossings are required to route two polarization-decomposed channels of each I/O port to duplicated PICs, resulting in excessive waveguide crossing losses. These requirements limit the scalability of polarization-diverse silicon photonic switches.

U.S. Pat. No. 10,715,588 teaches a polarization-insensitive silicon photonic switch system consisting of an array of horizontal waveguides in one layer and an array of vertical waveguides in another layer. These layers are physically separated far enough not to interact each other optically. Vertically moving couplers transfer light between waveguides in two different layers. The adiabatic nature of the moving couplers enable coupling for both polarizations (TE and TM). One drawback of such polarization-insensitive systems is that lights of both polarizations propagate in a single waveguide simultaneously and the birefringence of the waveguide causes differential group delay, resulting in increased bit-error-rate (BER).

### SUMMARY OF THE DISCLOSURE

A photonic integrated circuit (PIC) device is provided, comprising: a substrate; one or more rows of horizontal waveguides disposed on a first layer of the substrate, each row of horizontal waveguides comprising a first horizontal waveguide and a second horizontal waveguide; one or more columns of vertical waveguides disposed on a second layer of the substrate, each column of vertical waveguides comprising a first vertical waveguide and a second vertical waveguide; one or more input polarization-insensitive couplers configured to couple external light to the one or more rows of horizontal waveguides; an input polarization splitter rotator (PSR) coupled to each of the one or more input polarization-insensitive couplers, each input PSR being configured to split the coupled light into the first and second horizontal waveguides in each of the one or more rows of horizontal waveguides; and a matrix of polarization-diverse photonic switches arranged at intersections between the one or more rows of horizontal waveguides and the one or more rows of vertical waveguides, the polarization-diverse photonic switches being actuatable to transfer light from the first and second horizontal waveguides for a given row of horizontal waveguides to first and second vertical waveguides of an intersecting column of vertical waveguides.

In some aspects, the PIC further comprises an output PSR coupled to each of the one or more columns of vertical waveguides, each output PSR being configured to combine the light from the first and second vertical waveguides into a single output waveguide.

In some aspects, the PIC further comprises one or more output polarization-insensitive couplers coupled to each output waveguide.

In some aspects, the input PSRs are configured to split the input light into two orthogonal polarizations in two separate waveguides and rotate a polarization of one of the two separate waveguides to achieve the same polarization in the two separate waveguides.

In other aspects, the polarization-diverse photonic switches are micro-electro-mechanical-system (MEMS) switches.

In one aspect, the polarization-diverse photonic switches comprise first and second waveguide couplers disposed on a third layer of the substrate.

In some aspects, the third layer is above the first and second layers.

In other aspects, the third layer is between the first and second layers.

In some aspects, the first and second waveguide couplers are configured to be MEMS actuated to contact the first and second horizontal waveguides.

In one aspect, the first and second waveguide couplers are configured to be MEMS actuated to contact the first and second vertical waveguides.

In other aspects, the first and second horizontal waveguides are configured to be MEMS actuated to contact the first and second waveguide couplers.

In some aspects, the first and second vertical waveguides are configured to be MEMS actuated to contact the first and second waveguide couplers.

In other aspects, the polarization-diverse photonic switches comprise overlapped sections of the first and second horizontal waveguides with overlapped sections of the first and second vertical waveguides.

In some aspects, the overlapped sections comprise a number of turns or bends in each of the horizontal and vertical waveguides that allow for an overlap portion of the horizontal waveguides to align with an overlap portion of the vertical waveguides.

In one aspect, the overlap portion of the horizontal waveguides are parallel to the overlap portion of the vertical waveguides.

In other aspects, input and output ends of the horizontal waveguides are perpendicular to input and output ends of the vertical waveguides.

A photonic integrated circuit (PIC) device is provided, comprising: a substrate; one or more rows of horizontal waveguides disposed on a first layer of the substrate, each row of horizontal waveguides comprising a transmit port, a receive port, a first horizontal waveguide, and a second horizontal waveguide; one or more columns of vertical waveguides disposed on a second layer of the substrate, each column of vertical waveguides comprising a transmit port, a receive port, a first vertical waveguide, and a second vertical waveguide; a transmit polarization splitter rotator (PSR) coupled to each of the transmit ports of the horizontal waveguides and to each of the transmit ports of the vertical waveguides, each transmit PSR being configured to split light into the first and second horizontal waveguides in each of the one or more rows of horizontal waveguides and into first and second vertical waveguides in each of the one or more rows of vertical waveguides; and a matrix of polarization-diverse photonic switches arranged at intersections between the one or more rows of horizontal waveguides and the one or more rows of vertical waveguides, the polarization-diverse photonic switches being actuatable to transfer light from the first and second horizontal waveguides corresponding to a given transmit port to first and second vertical waveguides corresponding to a paired receive port, and to transfer light from the first and second vertical waveguides corresponding to a given transmit port to first and second horizontal waveguides corresponding to a paired receive port.

In some aspects, the PIC further comprises a receive PSR coupled to each of the receive ports of the horizontal waveguides and to each of the receive ports of the vertical waveguides, each receive PSR being configured to combine the light from the first and second vertical waveguides or the first and second horizontal waveguides into a single output waveguide.

In other aspects, the transmit PSRs are configured to split the light into two orthogonal polarizations in two separate waveguides and rotate a polarization of one of the two separate waveguides to achieve the same polarization in the two separate waveguides.

In some aspects, the polarization-diverse photonic switches are micro-electro-mechanical-system (MEMS) switches.

In other aspects, the polarization-diverse photonic switches comprise first and second waveguide couplers disposed on a third layer of the substrate, the first and second waveguide couplers being configured to couple the transmit port for a given row of horizontal waveguides with a receive port of a corresponding column of vertical waveguides.

In one aspect, the polarization-diverse photonic switches comprise third and fourth waveguide couplers disposed on the third layer of the substrate, the first and second waveguide couplers being configured to couple the transmit port for a given column of vertical waveguides with a receive port of a corresponding row of horizontal waveguides.

In some aspects, the third layer is above the first and second layers.

In additional aspects, the third layer is between the first and second layers.

In some aspects, the first and second waveguide couplers are configured to be MEMS actuated to contact the first and second horizontal waveguides.

In other aspects, the first and second waveguide couplers are configured to be MEMS actuated to contact the first and second vertical waveguides.

In some aspects, the first and second horizontal waveguides are configured to be MEMS actuated to contact the first and second waveguide couplers.

In one aspect, the first and second vertical waveguides are configured to be MEMS actuated to contact the first and second waveguide couplers.

In other aspects, the polarization-diverse photonic switches comprise overlapped sections of the first and second horizontal waveguides with overlapped sections of the first and second vertical waveguides.

In one aspect, the overlapped sections comprise a number of turns or bends in each of the horizontal and vertical waveguides that allow for an overlap portion of the horizontal waveguides to align with an overlap portion of the vertical waveguides.

In other aspects, the overlap portion of the horizontal waveguides are parallel to the overlap portion of the vertical waveguides.

In one aspect, input and output ends of the horizontal waveguides are perpendicular to input and output ends of the vertical waveguides.

A method of directing light through a photonic integrated circuit (PIC) is provided, comprising: inputting light into a row of horizontal waveguides on a first layer of the PIC; splitting the light into first and second horizontal waveguides of the row of horizontal waveguides; controlling an array of micro-electro-mechanical-system (MEMS) photonic switches to transfer light from the first and second horizontal waveguides to first and second vertical waveguides of a selected column of vertical waveguides; and outputting the light from the selected column of vertical waveguides.

In some aspects the method further comprises, before outputting the light, combining the light from the first and second vertical waveguides into a single output.

In another aspect, the method further comprises splitting the light into first and second horizontal waveguides in two orthogonal polarizations and then rotating a polarization of one of the first and second horizontal waveguides to achieve the same polarization in the first and second horizontal waveguides.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIGS. 1A and 1B depict the OFF and ON states of a polarization-insensitive switch with separate layers of input and output waveguides. Switching elements can comprise MEMS-actuated adiabatic couplers.

FIGS. 2A and 2B depict the OFF and ON states of a dual-channel polarization-diverse switch with separate layers of input and output waveguides. Orthogonal polarization components (TE and TM) are coupled to different channels of paired waveguides by polarization-splitter-rotator (PSR). Dual-channel MEMS switching elements couple both channels from one layer to the other. After switching, the polarization components are combined by another PSR.

FIGS. 3A-3F depict various embodiments of the dual-channel switching elements: FIGS. 3A-3B show the MEMS-actuated dual-channel couplers are a third layer above the input and output waveguides. FIGS. 3C-3D illustrate the MEMS-actuated dual-channel couplers sandwiched between the input and output waveguides. FIGS. 3E-3F show the switching elements comprising overlapping sections of the input and output waveguides. One or both waveguides are connected to MEMS actuators.

FIG. 4 depicts a polarization-diverse duplex switch that allows simultaneous transmit/receive (T/R) operation.

FIGS. 5A-5D depict various embodiments of the polarization-diverse duplex switching elements.

FIG. 6 depicts an embodiment of the polarization-insensitive duplex switch.

FIG. 7 depicts another embodiment of polarization-diverse switch without using dual-channel waveguides and switching elements.

FIG. 8 depicts an embodiment of a polarization splitter rotator (PSR).

FIGS. 9A-9B depict another embodiment of a dual-channel switching element.

FIG. 9A shows a 3D rendering of the switching element. FIG. 9B illustrates simulated mode profiles along the deformable waveguide coupler.

FIG. 10 depicts a 3D rendering of an embodiment of a dual-channel switching element.

### DETAILED DESCRIPTION

The present disclosure details novel photonic integrated circuits (PICs) that include polarization-diverse silicon photonic switches with multi-layer waveguides. Generally, the PICs of the present disclosure are configured to detect, generate, transport, and/or process light. The PICs of the present disclosure can be applied or used in a wide variety of fields including but not limited to fiber-optic communication, photonic computing, and light detection and ranging (LiDAR). The proposed PICs can include switches having two polarization-decomposed channels that propagate in closely spaced dual-channel waveguides, achieving polarization diverse operation without increasing the PIC area. By using two-layer waveguides and dual-channel micro-electro-mechanical-system (MEMS)-actuated switching elements to couple light from one layer to the other, the proposed scheme also eliminates waveguide crossings found in the prior arts.

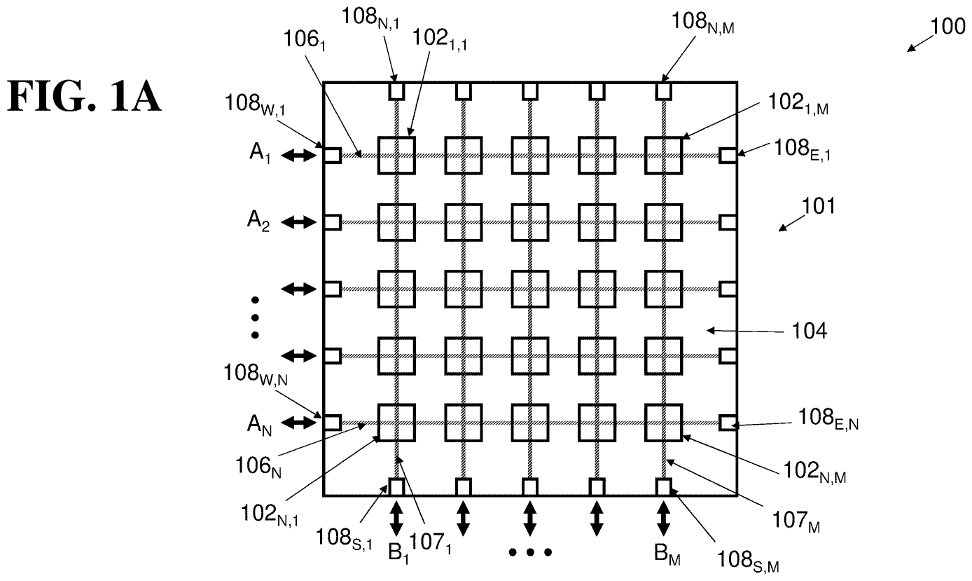

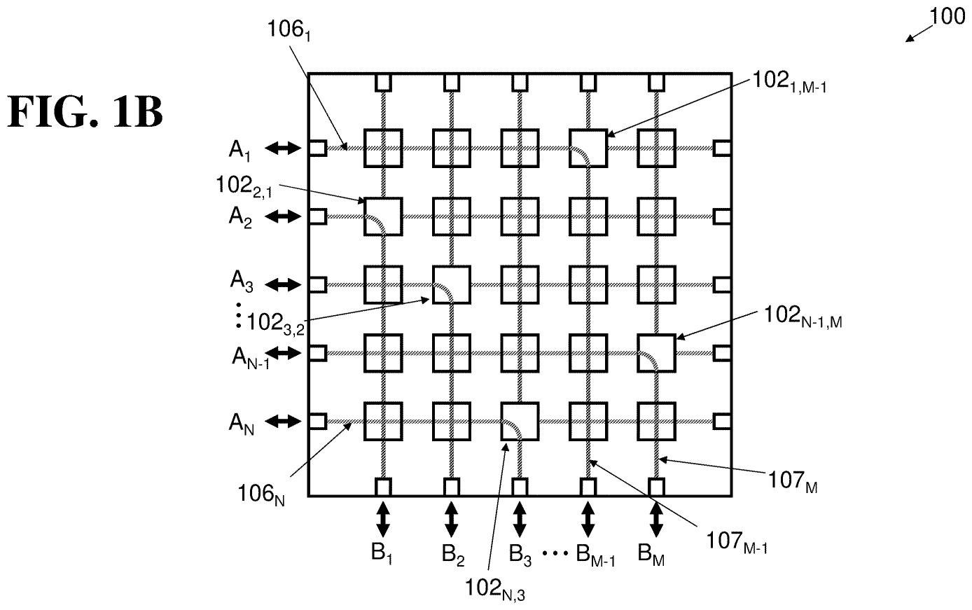

FIGS. 1A-1B show OFF and ON states, respectively of a PIC 100 that includes a matrix 101 of polarization-insensitive photonic switches 102 disposed on a substrate 104. The PIC can further include an array of horizontal waveguides 106 and another array of vertical waveguides 107 that are employed with the photonic switches 102 located at crossing points. The array of horizontal waveguides can be coupled to polarization-insensitive input/output (I/O) couplers 108 on each side of the waveguides to define ports in rows Al through AN, and the array of vertical waveguides can be coupled to polarization-insensitive I/O couplers 108 on each side of the waveguides to define ports in columns B₁ through B_{M}.

For ease of illustration and description, the photonic switches are labeled according to the rows and columns they intersect. Therefore, the photonic switch residing at the intersection of row A₁ and column B₁ is labeled as photonic switch 102_{1,1}, and the photonic switch residing at the intersection of row Ai and column BM is labeled as photonic switch 102_{1,M}. Similarly, the photonic switch residing at the intersection of row A_{N} and column B1 is labeled as photonic switch 102_{N,1}, and the photonic switch residing at the intersection of row A_{N} and column B_{M} is labeled as photonic switch 102_{N,M}. Similar labeling is used for the horizontal waveguides, vertical waveguides, and I/O couplers. As such, horizontal waveguides in rows A₁ through A_{N} are labeled as horizontal waveguides 106₁ through 106_{N}, and vertical waveguides in columns B₁ through B_{M} are labeled as vertical waveguides 107₁ through 107_{M}. The I/O couplers 108 are defined according to the side of the PIC they reside on in combination with the row or column number. Therefore, I/O couplers on the west side of the PIC (relative to the page) span are labeled as couplers 108_{w,1} through 108_{W,N}, I/O couplers on the north side of the PIC span are labeled as couplers 108_{N,1} through 108_{N,M}, I/O couplers on the east side of the PIC span are labeled as couplers 108_{E,1} through 108_{E,N}, and I/O couplers on the south side of the PIC span are labeled as couplers 108_{S,1} through 108_{S,M}. While not all elements are labeled in all of the figures, this labeling convention should be clear to one of ordinary skill in the art.

To demonstrate the switch operation with arbitrary polarizations, polarization-insensitive operation is required for all photonic components of the switch such as the I/O couplers, waveguide crossings, and photonic switches. This requirement is hard to achieve for conventional silicon photonic switches based on thermo-optic (TO)/electro-optic (EO) Mach-Zehnder interferometers (MZIs) or micro-ring resonators (MRRs) because rectangular-shaped waveguides inherently have birefringent nature and optimal conditions for light coupling between waveguides deployed laterally in a single layer varies for different polarizations.

In the embodiment of FIG. 1A, all the photonic switches 102 are in the OFF position, which means that light passes through the horizontal waveguides 106 and/or vertical waveguides 107 without being switched into a different waveguide or layer. For example, light passing through horizontal waveguide 1061 remains in that waveguide, and light passing through vertical waveguide 107₁ remains in that waveguide. In the embodiment of FIG. 1B, however, photonic switches 102_{1,M-1}, 102_{2,1}, 102_{3,2}, 102_{N-1,M}, and 102_{N,3} are switched to the ON position, thereby causing light passing through the horizontal waveguide 106₁ to be switched into the vertical waveguide 107_{M-1} with switch 102_{1,M-1}. The path of light through the other ON switches is also shown in the figure.

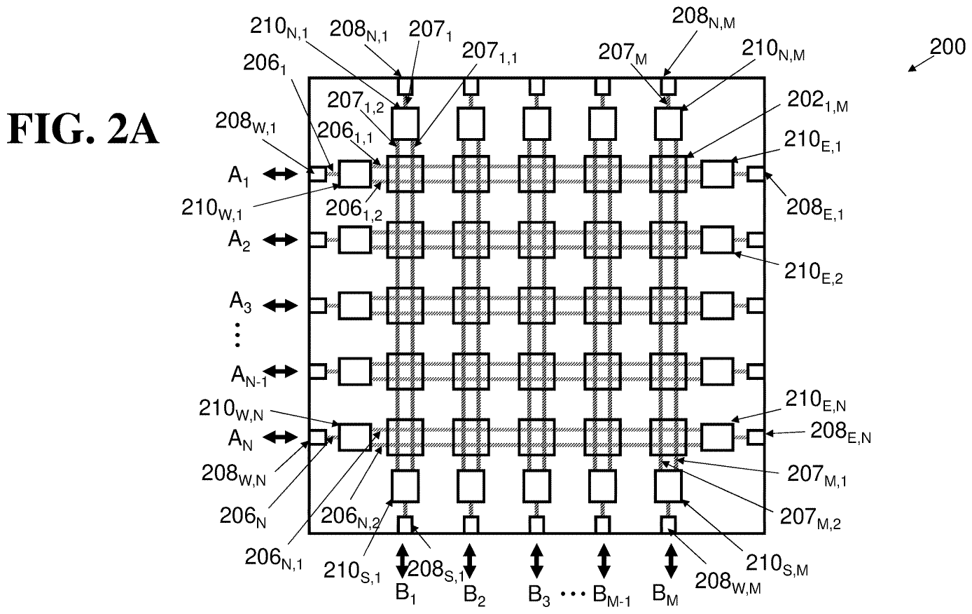

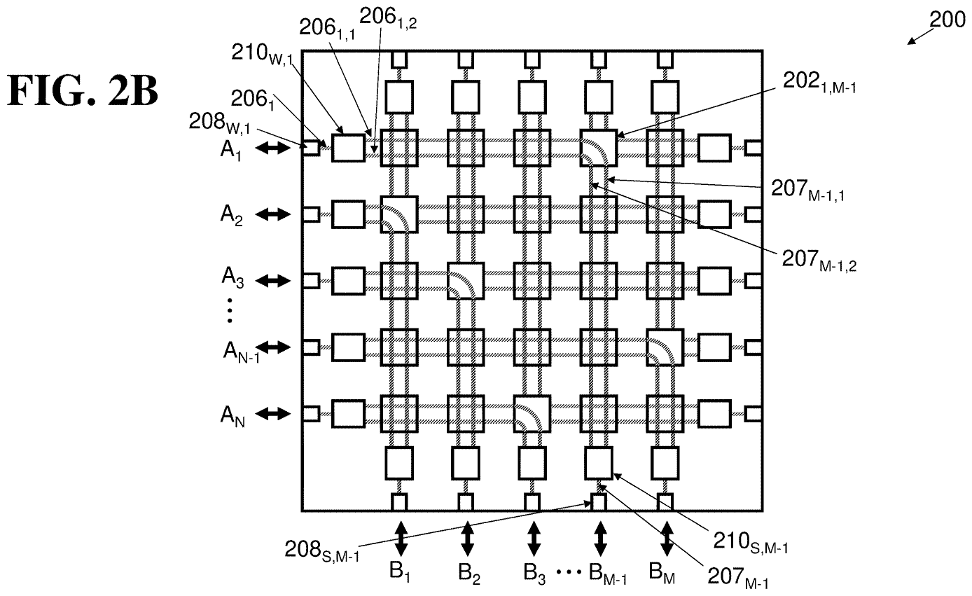

FIGS. 2A-2B illustrate a schematic of a PIC 200 that includes a matrix of polarization-diverse silicon photonic switches 202. The photonic switches are shown in the OFF state in FIG. 2A, with some of the switches in the ON state in FIG. 2B. As shown, the PIC can include an array of horizontal waveguides 206₁ through 206_{N} in one layer of the substrate and an array of vertical waveguides 207₁ through 207_{M} in another layer of the substrate. For example, the various layers of the waveguides can be integrated through wafer fabrication processes into different layers on the substrate of the PIC. Light is coupled from an external fiber or a free-space beam to a waveguide via a polarization-insensitive couplers 208 (e.g., west couplers 208_{W,1} through 208_{W,N}, east couplers 208_{E,1} through 208_{E,N}, north couplers 208_{N,1} through 208_{N,M}, and south couplers 208_{S,1} through 208_{S,M},). One or more polarization splitter rotators (PSR) 210 (e.g., west PSRs 210_{W,1} through 210_{W,N}, east PSRs 210_{E,1} through 210_{E,N}, north PSRs 210_{N,1} through 210_{N,M}, and south PSRs 210_{S,1} through 210_{S,M},) in each row/column are configured to split the coupled light into two orthogonal polarizations in two separate waveguides (e.g., horizontal waveguide 206₁ is split into two waveguides 206_{1,1} and 206_{1,2}, horizontal waveguide 206_{N} is split into two waveguides 206_{N,1} and 206_{N,2}, vertical waveguide 207₁ is split into two waveguides 207_{1,1} and 207_{1,2}, and vertical waveguide 207_{M} is split into two waveguides 207_{M,1} and 207_{M,2}) and the polarization of one waveguide is rotated to the same polarization as the other waveguide. Put another way, coupled light is split and rotated into paired waveguides in each row/column and the polarization of both paired waveguides to have the same polarization. As the two waveguides have the same dimensional shapes and the lights in them have same polarizations, the photonic switches along the waveguides are not subject to differential group delay.

Referring to FIG. 2B, the split lights in the two parallel waveguides propagate until they reach an ON-state photonic switch. In an ON-state switch cell, lights in the two parallel waveguides are transferred to another pair of waveguides in the second layer by a pair of waveguide couplers. The transferred lights in the pair of the second layer waveguides propagate to another PSR and combine to a single waveguide. The combined light is finally coupled out to an external fiber or a free-space beam via a polarization-insensitive coupler. In one specific example in FIG. 2B, coupled light in row A₁ through polarization-insensitive coupler 208_{W,1} propagates in a waveguide 206₁ to PSR 210_{W,1}, which splits and rotates the light into waveguides 206_{1,1} and 206_{1,2} having the same polarization. The light travels these waveguides until it reaches photonic switch 202_{1,M-1} in the ON state, which transfers the light from waveguides 206_{1,1} and 206_{1,2} in a first layer of the substrate to waveguides 207_{1,1} and 207_{1,2} in a second layer of the substrate. The transferred light propagates in these waveguides through PSR 210_{S,M-1}, which combines the light back into a waveguide 207_{M-1} to be coupled out to external fiber or free space via polarization-insensitive coupler 208_{S,M-1}. Other photonic switches in the matrix shown in FIG. 2B are also shown in the ON state, illustrating the transfer of light between the rows and columns of waveguides of the PIC in the same manner as described above.

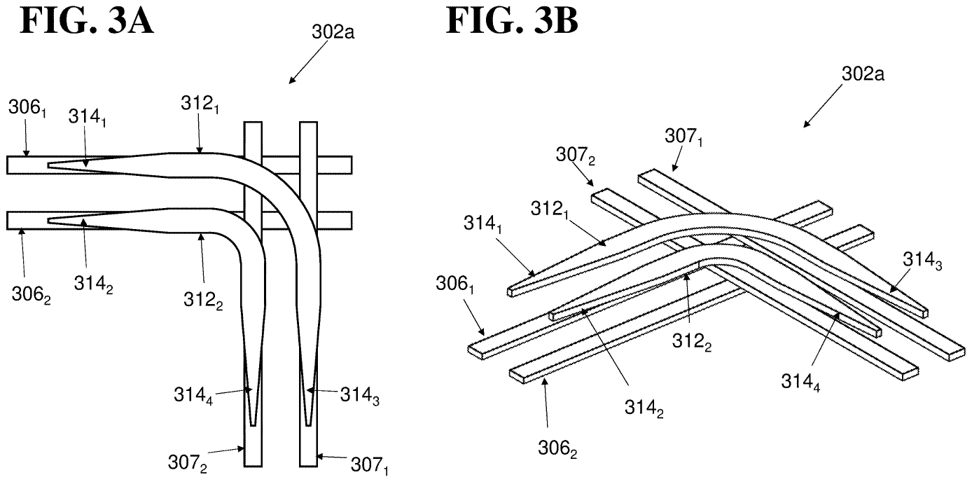

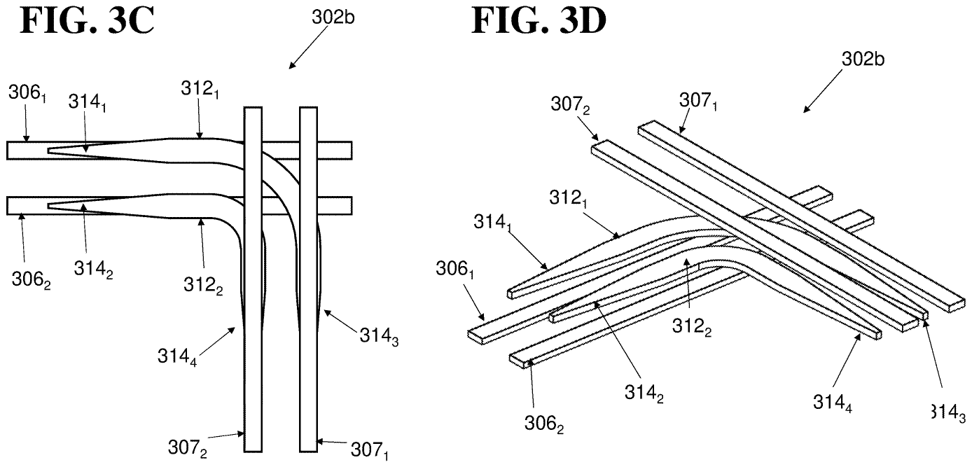

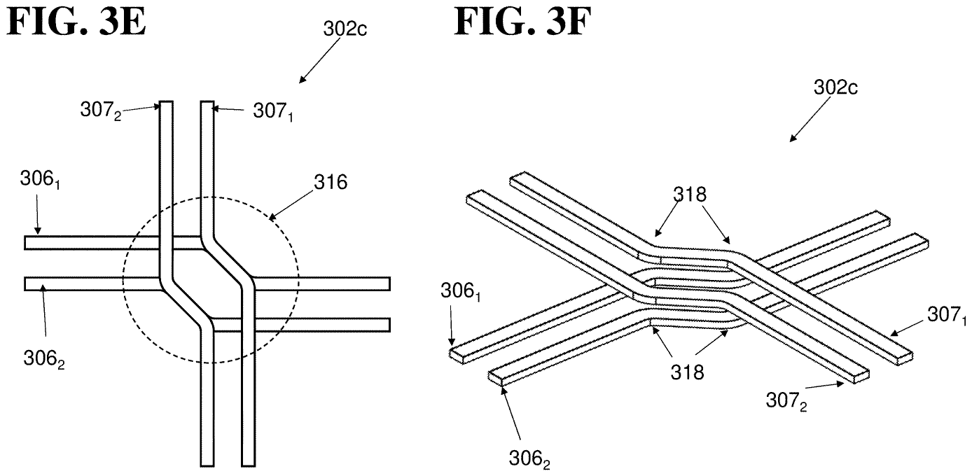

FIGS. 3A-3B show top and perspective views of an embodiment of a photonic switch or switch cell 302a. As described above, the switch cell 302a can comprise a MEMS switch that includes MEMS elements that can be actuated to control the operation of the switch cell. A pair of horizontal waveguides 306₁ and 306₂ are implemented in a first layer from the substrate (not shown). A pair of vertical waveguides 307₁ and 307₂ are implemented in a second layer from the substrate. A pair of waveguide couplers 312₁ and 312₂ are implemented in a third layer from the substrate. If the first, second, and third layers of the substrate are considered to be vertical layers on the substrate, then the first layer can comprise the bottom layer, the second layer can comprise the middle layer, and the third layer can comprise the top layer. In an OFF state, the waveguide couplers are located far from the horizontal and vertical waveguides. In an ON state, a first end 314₁ and 314₂ of the paired waveguide couplers are MEMS actuated to be pulled down to the pair of the horizontal waveguides in the first layer and light coupling is achieved between the horizontal waveguides 306₁ and 306₂ and the waveguide couplers. A second end 314₃ and 314₄ of the paired waveguide couplers are MEMS actuated to be pulled down to the vertical waveguides in the second layer and light coupling is achieved between the waveguide couplers and the vertical waveguides. In another embodiment, instead of MEMS actuating the waveguide couplers, the horizontal waveguides and/or the vertical waveguides can be MEMS actuated to be pulled up toward the coupler waveguides to achieve light coupling while the coupler waveguides keep staying in the same level. In another embodiment, both the horizontal/vertical waveguides and coupler waveguides are pulled toward each other and join at the middle level. In any of the embodiments described herein, the width of the waveguides and/or the waveguide couplers can vary in thickness or width. Additionally, the waveguides and/or the waveguide couplers can be tapered.

FIGS. 3C-3D show top and perspective views of another embodiment of a photonic switch or switch cell 302b. In this embodiment, the waveguide couplers 312₁ and 312₂ are implemented in the middle or second layer of the substrate between the layers of the horizontal waveguides 306₁ and 306₂ and the vertical waveguides 307₁ and 307₂. In an OFF state, the waveguide couplers are far from the horizontal waveguides and the vertical waveguides so that they do not optically interact. In an ON state, the light coupling can be achieved by MEMS actuating the waveguide couplers to move them toward the horizontal waveguides and the vertical waveguides. For example, since the waveguide couplers are in the middle layer in this embodiment, this can comprise MEMS actuating the first ends 314₁ and 314₂ of the waveguide couplers to be pulled down towards the horizontal waveguides and MEMS actuating the second ends 314₃ and 314₄ to be pulled up towards the vertical waveguides. Alternatively, and combination of MEMS actuating the waveguide couplers, the horizontal waveguides, and/or the vertical waveguides can be implemented, including moving the horizontal/vertical waveguides toward the waveguide couplers, or moving both the horizontal/vertical waveguides and the waveguides couplers toward each other simultaneously.

FIGS. 3E-3F show top and perspective views of another embodiment of a photonic switch or switch cell 302c. In this embodiment, the light coupling is not achieved by a separate layer of waveguide couplers, but by overlapped section(s) 316 of the horizontal waveguides 3061 and 3062 and vertical waveguides 3071 and 3072 which are disposed in first and second layers of the substrate. As shown in FIGS. 3E-3F, in the overlap section 316, each of the horizontal and vertical waveguides can include a number of turns or bends 318 that allow for an overlap portion of the horizontal waveguides in the overlap section 316 to align or coincide with a corresponding overlap portion of the vertical waveguides in the overlap section. The input and output ends of the horizontal waveguides remain parallel with another, as do the input and output ends of the vertical waveguides. However, the turns or bends in each of the waveguides allow for alignment of the overlap portion of the vertical waveguides with the overlap portion of the horizontal waveguides. In one example, the bends or turns can comprise 45 degree bends or turns to facilitate overlap between the vertical and horizontal waveguides while still allowing the horizontal waveguides to be generally perpendicular to the vertical waveguides. By way of further explanation, the overlap portion of the horizontal waveguides align with and are parallel to the overlap portion of the vertical waveguides, while the input and output ends of the horizontal waveguides are perpendicular to the input and output ends of the vertical waveguides.

In an OFF state, the two layers of waveguides 306a/c and 306b/d are sufficiently spaced from each other so that they do not optically interact. In an ON state, light is coupled by MEMS actuating the horizontal waveguides and/or the vertical waveguides toward each other. The widths of the waveguides in the overlapped sections can stay in constant as conventional directional couplers or can be tapered as adiabatic couplers.

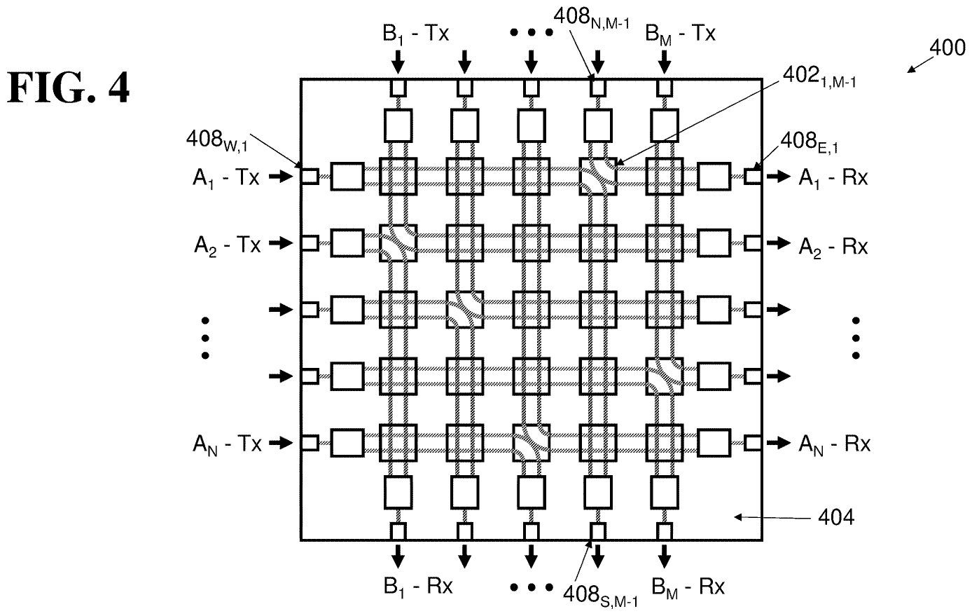

The proposed polarization-diverse switches are bi-directional owing to the reciprocal nature of light propagation in linear isotropic medium. However, optical network nodes typically possess separate transmit (Tx) and receive (Rx) ports, which requires optical circulators at each port of a bi-directional switch or duplicated switches for Tx and Rx channels. FIG. 4 shows an embodiment of a PIC 400 on a substrate 404 that includes an array or matrix of polarization-diverse Tx/Rx duplex switches 402 without implementing optical circulators or switch duplication. The PIC can include components previously described above including couplers 408, PSRs 410, and vertical and horizontal waveguides as shown. In the proposed PIC, a pair of West end ports and East end ports of a horizontal waveguide (e.g., couplers 408_{W,1} and 408_{E,1}) form a Tx/Rx pair of a switch port (A₁, A₂, . . . , A_{N}). Similarly, a pair of North end ports and South end ports of a vertical waveguide (e.g., couplers 408_{N,M-1} and 408_{S,M-1}) form a Tx/Rx pair of another switch port (B₁, B₂, . . . , B_{M}). When a switch cell (n, m) turns on, the Tx and Rx ports of the corresponding cell are connected simultaneously (Aₙ-Tₓ and Bₘ-Rx; Aₙ-Rx and Bₘ-Tx). For example, when switch 402_{1,M-1} is turned on, couplers 408_{W,1} and 408_{S,M-1} form a Tx/Rx pair and couplers 408_{N,M-1} and 408_{E,1} form a Tx/Rx pair.

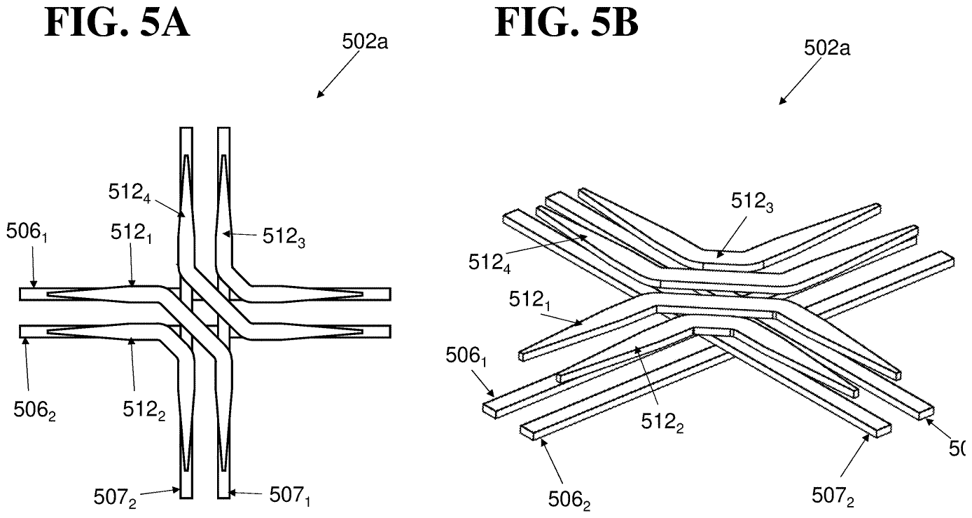

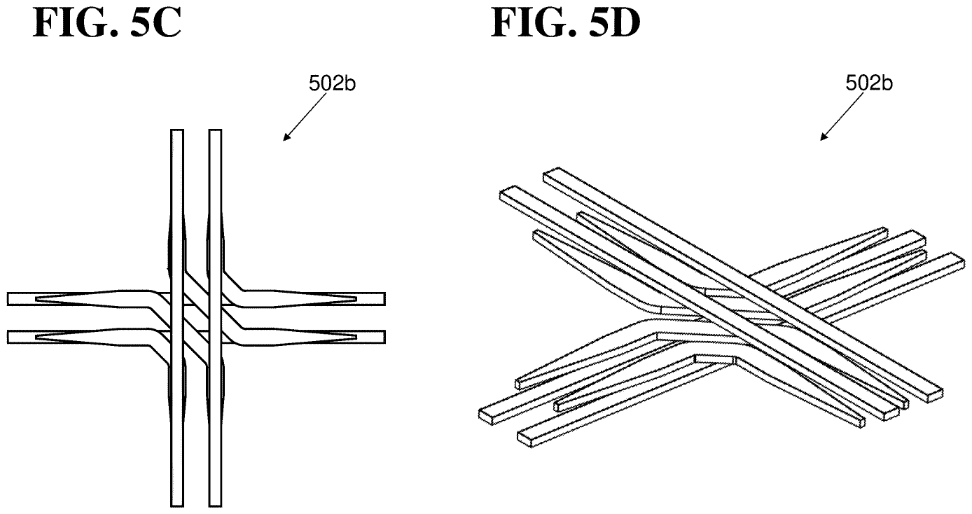

FIGS. 5A-5D show embodiments of photonic switches or duplex switch cells 502a/502b with three layers of waveguides-horizontal waveguides, vertical waveguides and waveguide couplers. Their operation principals are similar to the previous embodiments without Tx/Rx duplexing shown in FIGS. 3A-3D. The only difference is that a duplex switch has additional pair of waveguide couplers 512₃ and 512₄ to achieve light coupling not only between West and South ports, but also between North and East ports. For example, in FIGS. 5A-5B, waveguide couplers 512₁ and 512₂ couple West ports of the horizontal waveguides 506₁ and 506₂ to South ports of the vertical waveguides 507₁ and 507₂. Furthermore, waveguide couplers 512₃ and 512₄ couple North ports of the vertical waveguides 507₁ and 507₂ to East ports of the horizontal waveguides 506₁ and 506₂. As described above, any combination of the waveguides or waveguide couplers can be MEMS actuated to make the optical connection(s). In FIGS. 5A-5B, the horizontal waveguides are on the first (bottom) layer of the substrate, the vertical waveguides are on the second (middle) layer of the substrate, and the waveguide couplers are on the third (top) layer of the substrate. In the embodiment of FIGS. 5C-5D, however, the switches 502b are designed with waveguide couplers in the second (middle) layer and the vertical waveguides in the third (top) layer. As described above, the waveguide couplers and/or the waveguides themselves can be MEMS actuated to make the optical connection(s) between waveguides and couplers.

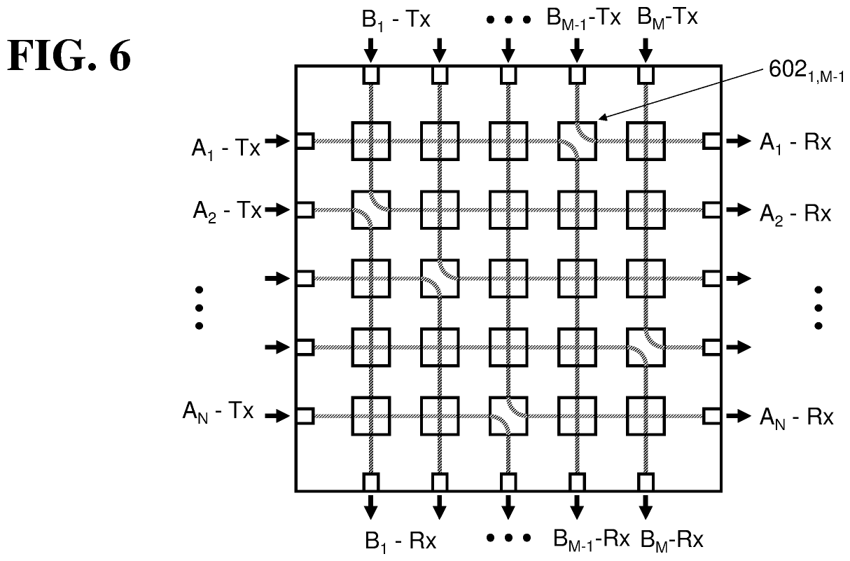

In another embodiment, a Tx/Rx duplex switch can be demonstrated without a separate layer of waveguide couplers, similar to the embodiment as shown in FIGS. 3E-3F. In the proposed duplex switches, a pair of Tx and Rx of a single port is connected by a waveguide, which may cause crosstalk between Tx and Rx ports. In some embodiments, movable optical attenuators can be employed to reduce channel crosstalk between Tx and Rx ports in ON state. Similarly, an array of polarization-insensitive duplex switches 602 can be also demonstrated as shown in FIG. 6. In this example, single waveguides are used in each row of the horizontal waveguides and in each column of the vertical waveguides. The polarization-insensitive duplex switch 602_{1,M-1} can couple the A₁ Tx port to the B_{M-1} Rx port while also coupling the B_{M-1} Tx port to the A₁ Rx port.

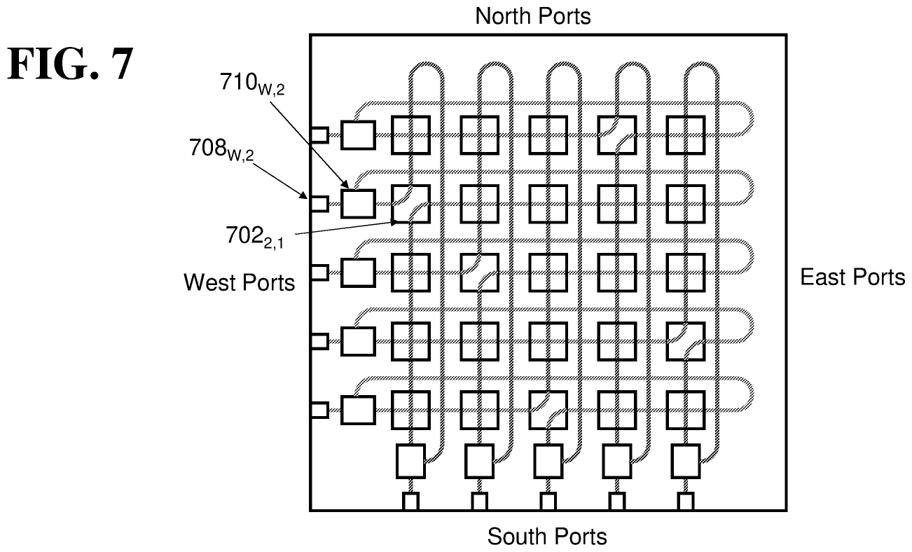

Polarization-diverse switches proposed earlier in this disclosure (FIGS. 2A-2B) employ dual-channel waveguides in switch cells to deliver two split polarizations. FIG. 7 shows a potential embodiment of polarization-diverse switch without waveguide duplications in switch cells. In the proposed architecture, light coupled at coupler 708_{W,2} is split into polarizations with the PSR 710_{W,2} and fed into opposite ends of a horizontal waveguide (West and East ends) or a vertical waveguide (North and South ends). In an ON state, a switch cell 702_{2,1} forms optical connections between West and North ports and between East and South ports.

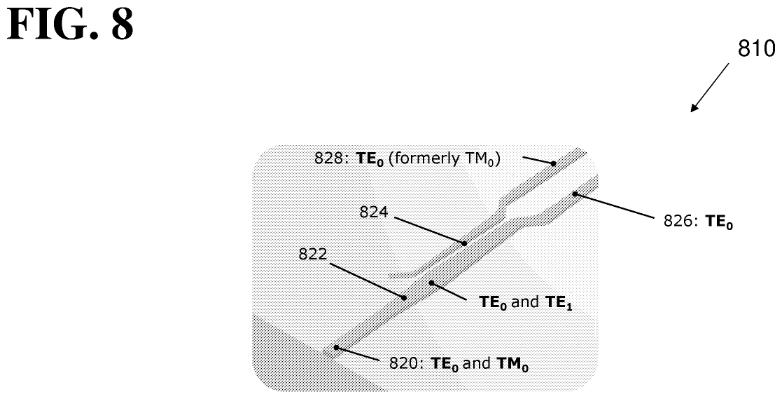

FIG. 8 depicts an embodiment of a polarization splitter rotator (PSR) 810, which can include an input 820, a rotator 822, a splitter 824, and first and second outputs 826 and 828. The TE₀ mode at the input 822 propagates to the first output 826 without polarization change. The TM₀ mode at the input 822 is converted into the TE₁ mode and then converted to the TE₀ mode at the second output 828.

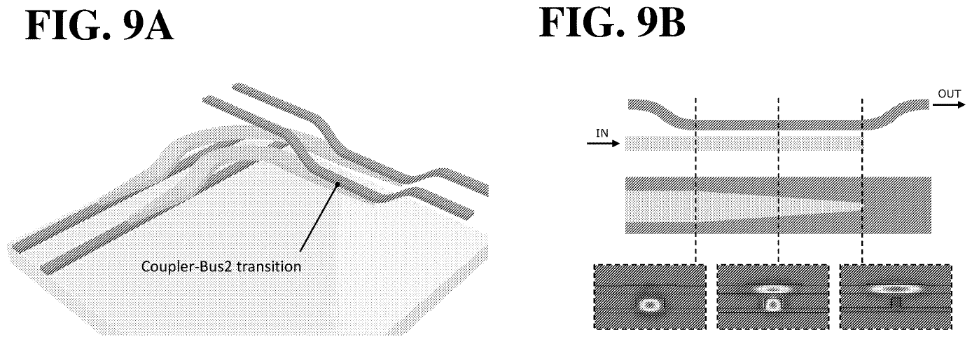

FIGS. 9A-9B depict another embodiment of a dual-channel switching element. FIG. 9A shows a 3D rendering of the switching element. FIG. 9B illustrates simulated mode profiles along the deformable waveguide coupler.

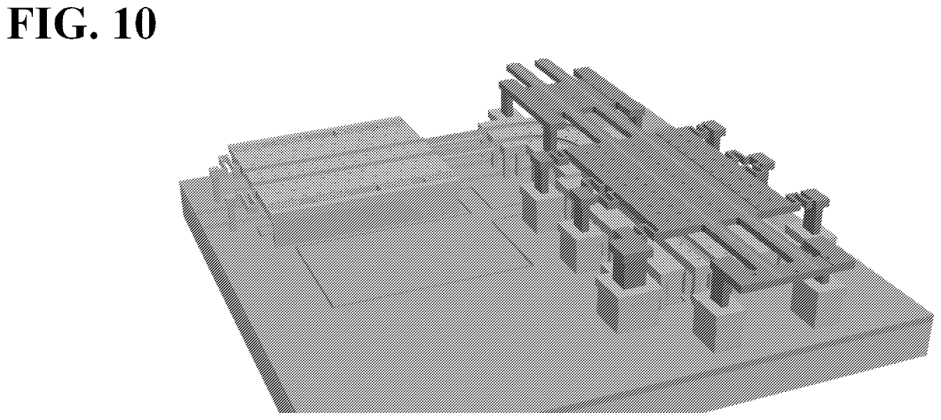

FIG. 10 depicts a 3D rendering of an embodiment of a dual-channel switching element.

Paired waveguide couplers of the proposed polarization diverse switches in this disclosure can be actuated by one shared actuator in each cell. Typically, the actuators dominate the footprint of a switch and employing two parallel waveguides has negligible effect on the footprint. Therefore, proposed polarization-diverse switches do not require doubled chip areas unlike conventional polarization-diverse silicon photonic devices in which the entire PIC needs to be duplicated for two split polarizations.

1. A photonic integrated circuit (PIC) device, comprising:
a substrate;
one or more rows of horizontal waveguides disposed on a first layer of the substrate, each row of horizontal waveguides comprising a first horizontal waveguide and a second horizontal waveguide;
one or more columns of vertical waveguides disposed on a second layer of the substrate, each column of vertical waveguides comprising a first vertical waveguide and a second vertical waveguide;
one or more input polarization-insensitive couplers configured to couple external light to the one or more rows of horizontal waveguides;
an input polarization splitter rotator (PSR) coupled to each of the one or more input polarization-insensitive couplers, each input PSR being configured to split the coupled light into the first and second horizontal waveguides in each of the one or more rows of horizontal waveguides; and
a matrix of polarization-diverse photonic switches arranged at intersections between the one or more rows of horizontal waveguides and the one or more rows of vertical waveguides, the polarization-diverse photonic switches being actuatable to transfer light from the first and second horizontal waveguides for a given row of horizontal waveguides to first and second vertical waveguides of an intersecting column of vertical waveguides.

2. The PIC device of claim 1, further comprising an output PSR coupled to each of the one or more columns of vertical waveguides, each output PSR being configured to combine the light from the first and second vertical waveguides into a single output waveguide.

3. The PIC device of claim 2, further comprising one or more output polarization-insensitive couplers coupled to each output waveguide.

4. The PIC device of claim 1, wherein the input PSRs are configured to split the input light into two orthogonal polarizations in two separate waveguides and rotate a polarization of one of the two separate waveguides to achieve the same polarization in the two separate waveguides.

5. The PIC device of claim 1, wherein the polarization-diverse photonic switches are micro-electro-mechanical-system (MEMS) switches.

6. The PIC device of claim 1, wherein the polarization-diverse photonic switches comprise first and second waveguide couplers disposed on a third layer of the substrate.

7. The PIC device of claim 6, wherein the third layer is above the first and second layers.

8. The PIC device of claim 6, wherein the third layer is between the first and second layers.

9. The PIC device of claim 6, wherein the first and second waveguide couplers are configured to be MEMS actuated to contact the first and second horizontal waveguides.

10. The PIC device of claim 6, wherein the first and second waveguide couplers are configured to be MEMS actuated to contact the first and second vertical waveguides.

11. The PIC device of claim 6, wherein the first and second horizontal waveguides are configured to be MEMS actuated to contact the first and second waveguide couplers.

12. The PIC device of claim 6, wherein the first and second vertical waveguides are configured to be MEMS actuated to contact the first and second waveguide couplers.

13. The PIC device of claim 1, wherein the polarization-diverse photonic switches comprise overlapped sections of the first and second horizontal waveguides with overlapped sections of the first and second vertical waveguides.

14. The PIC device of claim 13, wherein the overlapped sections comprise a number of turns or bends in each of the horizontal and vertical waveguides that allow for an overlap portion of the horizontal waveguides to align with an overlap portion of the vertical waveguides.

15. The PIC device of claim 14, wherein the overlap portion of the horizontal waveguides are parallel to the overlap portion of the vertical waveguides.

16. The PIC device of claim 15, wherein input and output ends of the horizontal waveguides are perpendicular to input and output ends of the vertical waveguides.

17. A photonic integrated circuit (PIC) device, comprising:
a substrate;
one or more rows of horizontal waveguides disposed on a first layer of the substrate, each row of horizontal waveguides comprising a transmit port, a receive port, a first horizontal waveguide, and a second horizontal waveguide;
one or more columns of vertical waveguides disposed on a second layer of the substrate, each column of vertical waveguides comprising a transmit port, a receive port, a first vertical waveguide, and a second vertical waveguide;
a transmit polarization splitter rotator (PSR) coupled to each of the transmit ports of the horizontal waveguides and to each of the transmit ports of the vertical waveguides, each transmit PSR being configured to split light into the first and second horizontal waveguides in each of the one or more rows of horizontal waveguides and into first and second vertical waveguides in each of the one or more rows of vertical waveguides; and
a matrix of polarization-diverse photonic switches arranged at intersections between the one or more rows of horizontal waveguides and the one or more rows of vertical waveguides, the polarization-diverse photonic switches being actuatable to transfer light from the first and second horizontal waveguides corresponding to a given transmit port to first and second vertical waveguides corresponding to a paired receive port, and to transfer light from the first and second vertical waveguides corresponding to a given transmit port to first and second horizontal waveguides corresponding to a paired receive port.

18. The PIC device of claim 17, further comprising a receive PSR coupled to each of the receive ports of the horizontal waveguides and to each of the receive ports of the vertical waveguides, each receive PSR being configured to combine the light from the first and second vertical waveguides or the first and second horizontal waveguides into a single output waveguide.

19. The PIC device of claim 17, wherein the transmit PSRs are configured to split the light into two orthogonal polarizations in two separate waveguides and rotate a polarization of one of the two separate waveguides to achieve the same polarization in the two separate waveguides.

20. The PIC device of claim 17, wherein the polarization-diverse photonic switches are micro-electro-mechanical-system (MEMS) switches.

21.-35. (canceled)
